(19) United States
(12) Patent Application Publication
(10) Pub. No.: US 2009/0160976 A1
(43) Pub. Date: Jun. 25, 2009

(54) DIGITAL PHOTOGRAPHIC CAMERA WITH BRIGHTNESS COMPENSATION AND COMPENSATION METHOD THEREOF

(75) Inventors: Parn-Far CHEN, Hsinchu City (TW); Fei-Jen TENG, Fongshan City (TW)

Correspondence Address: Workman Nydegger;1000 Eagle Gate Tower, 60 East South Temple, Salt Lake City, UT, 84111, US

(73) Assignee: Altek Corporation, Hsinchu (TW)

(21) Appl. No.: 12/180,744

(22) Filed: Jul. 28, 2008

(30) Foreign Application Priority Data
Dec. 21, 2007 (TW) 096149521

(51) Int. Cl. H04N 9/68

(52) U.S. Cl. 348/234; 348/E09.053

(57) ABSTRACT

A digital photographic camera with brightness compensation and a compensation method thereof are applied for the brightness compensation of the digital photographic camera when shooting under different environments so as to maintain a frame rate. The camera includes a light measuring unit, a sensor, a light source generator, a light modulation unit, an operational unit, and a storage unit. The light measuring unit is used for sensing the environment brightness of the camera. The light modulation unit is coupled to the light source generator and used for controlling luminance of the light source generator. The operational unit is coupled to the light measuring unit and the light source generator, and executes a brightness calibration process for calibrating a brightness sensing reference value of the light measuring unit and a brightness compensation process for adjusting the luminance of the light source generator according to the environment brightness of the camera.

### CROSS-REFERENCE TO RELATED APPLICATIONS

This non-provisional application claims priority under 35 U.S.C. §119(a) on Patent Application No(s). 096149521 filed in Taiwan, R.O.C. on Dec. 21, 2007 the entire contents of which are hereby incorporated by reference.

### BACKGROUND OF THE INVENTION

1. Field of Invention

The present invention relates to a method of adjusting shooting parameters for a digital photographic camera, and more particularly to a digital photographic camera with brightness compensation and a compensation method thereof applicable for the brightness compensation of the digital photographic camera when shooting under different brightness environments so as to maintain a frame rate of digital images.

2. Related Art

With the development of digital images, the digital camera may be used to record the pictures desired by the user, and the digital photographic camera may also be used to shoot the dynamic videos. The video shot by the digital photographic camera may be considered to be constituted by a plurality of pictures. When the environmental brightness is allowable, the shooting frame rate of the digital photographic camera is usually 30 frames per second. The higher the frame rate is, the smoother the playback effect is. The overly low frame rate may cause a drop-frame phenomenon in the playback of the video. In other words, drop-frame phenomenon is generated in the playback of the video.

FIG. 1 is a schematic view of a conventional adjustment method. In order to maintain a certain shooting frame rate, the digital video camera may adjust the gain value of a sensor in different brightness. The conventional adjustment method includes detecting the external environmental brightness (Step 110); selecting a compensation method; adjusting the gain value of the sensor (Step S121); adjusting the shooting frame rate (Step S122); and determining whether the definition of the digital images is achieved or not.

The gain value of the sensor is used for adjusting the light acceptance capability of the sensor. Being limited by the electronic characteristics of the sensor, the noise will be enhanced due to the increase of the gain value of the sensor. Otherwise, the shooting frame rate is adjusted to increase the light acceptance time of the sensor. However, a low frame rate will cause the drop-frame phenomenon in the video playback.

### SUMMARY OF THE INVENTION

In view of the above problems, the present invention is directed to a digital photographic camera with brightness compensation applied for the brightness compensation of the digital photographic camera when shooting under different brightness environments so as to maintain a frame rate of digital images.

As embodied and broadly described herein, the digital photographic camera with brightness compensation disclosed in the present invention includes a light measuring unit, a sensor, a light source generator, a light modulation unit, an operational unit, and a storage unit.

The light measuring unit is used for sensing an external brightness of the digital photographic camera. The sensor is used for shooting a plurality of frames of digital image. The light source generator is used for illuminating the digital photographic camera. The light modulation unit is electrically connected with the light source generator, and used for controlling the luminance of the light source generator. The operational unit is electrically connected with the light measuring unit and the light source generator, and executes a brightness calibration process for calibrating a brightness sensing reference value of the light measuring unit and a brightness compensation means for adjusting the luminance source device according to the external brightness of the digital photographic camera. The storage unit is electrically connected with the operational unit for storing the brightness compensation means and the brightness calibration process.

The present invention is directed to a brightness compensation method for a digital photographic camera, which is applicable for the brightness compensation of the digital photographic camera when shooting under different brightness environments so as to maintain a frame rate of digital images.

As embodied and broadly described herein, the brightness compensation method for a digital photographic camera disclosed in the present invention includes setting a brightness reference value of the digital photographic camera; deciding a shooting frame rate of the digital photographic camera according to the brightness reference value and an external brightness of the digital photographic camera; and adjusting the luminance of the light source generator, such that the shooting frame rate of the digital photographic camera is higher than a frame threshold.

The digital photographic camera with brightness compensation and the brightness compensation method thereof provided in the present invention are used for appropriately adjusting the luminance of an external light source of digital photographic camera when shooting under different light sources, such that the digital photographic camera may maintain the frame rate of the digital images without reducing the image quality in different environmental brightness. Besides, the adjustment on the gain value of the sensor is avoided, so as to reduce the image noise due to the increase the gain value.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a conventional adjustment method.

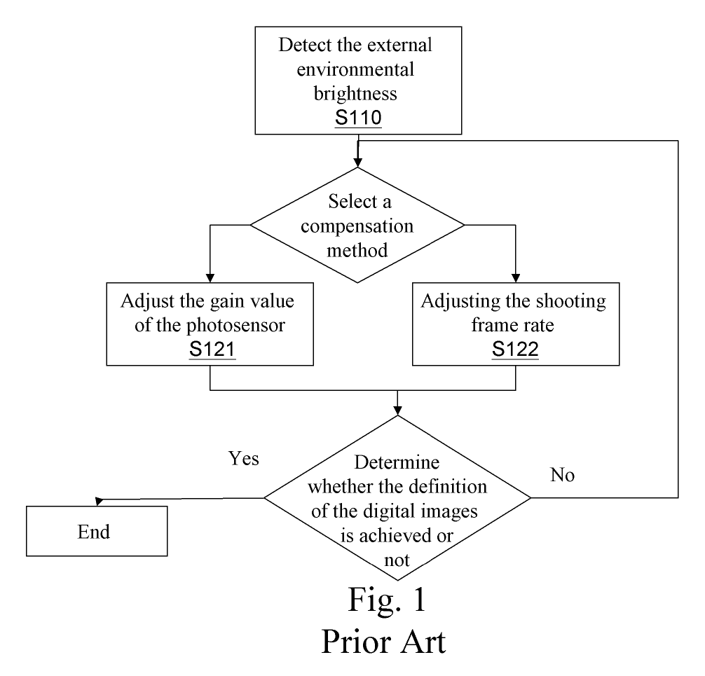

FIG. 2 is a schematic architecture diagram of the present invention.

FIG. 3 is a schematic view of an operation procedure of the present invention.

FIG. 4 shows a brightness to light source adjustment curve.

### DETAILED DESCRIPTION OF THE INVENTION

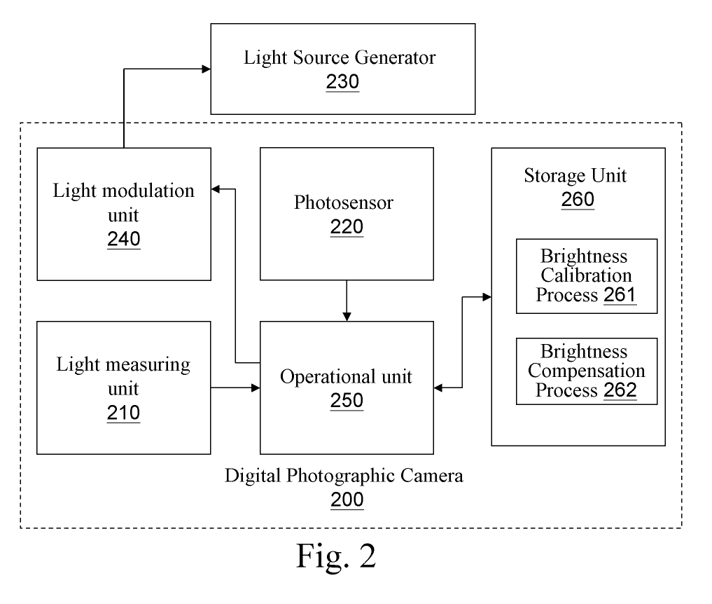

FIG. 2 is a schematic architecture diagram of the present invention. The digital photographic camera with brightness compensation 200 includes a light measuring unit 210, a sensor 220, a light source generator 230, a light modulation unit 240, an operational unit 250, and a storage unit 260.

The light measuring unit 210 is disposed on the external side of the digital photographic camera 200. The light measuring unit 210 is used for sensing an external brightness of the digital photographic camera 200. In this embodiment, the external brightness of the digital photographic camera 200 refers to the environmental brightness at shooting, or the environmental brightness of the shooting target. The sensor 220 is used for shooting a plurality frames of digital image. The acceptable video playback rate for human eyes is usually 30 frames per second. If the frame rate is lower than 30 frames/sec, human eyes may feel the drop-frame phenomenon during the video playback. In a high brightness environment, the digital photographic camera 200 may increase the frame rate, and in a low brightness environment, the digital photographic camera 200 may lower the shooting frame rate.

The sensor 220 is electrically connected with the operational unit 250 for shooting digital images. The sensor 220 may be a charge-coupled device (CCD) or a complementary metal-oxide-semiconductor (CMOS).

The light source generator 230 is electrically connected with the digital photographic camera 200 and used for illuminating the digital photographic camera 200. The light modulation unit 240 is disposed in the digital photographic camera 200, and electrically connected between the light source generator 230 and the operational unit 250. The light modulation unit 240 is used for controlling the luminance of the light source generator 230. The operational unit 250 is electrically connected with the light measuring unit 210 and the light source generator 230, and executes a brightness calibration process 261 and a brightness compensation means 262. The brightness calibration process 261 is used for calibrating a brightness sensing reference value of the light measuring unit 210. The brightness sensing reference value is used for adjusting the photosensitivity of the sensor 220. The higher the brightness sensing reference value is, the higher the light acceptance capacity in a low brightness shooting environment becomes, and vice versa.

Different digital photographic cameras 200 requires for different environmental brightness. Herein a household digital video camera and an endoscopic video camera are taken as an example. The household digital video camera is usually used in an outdoor environment, and has a bright environmental brightness. Therefore, the household digital video camera is set at a low brightness sensing reference value. The endoscopic video camera is usually used for shooting visceral organs of human being, which has almost no environmental brightness. If the external light source is used directly to perform compensation, the sensor 220 may have a wrong determination on light acceptance due to light reflection and other factors, such that the endoscopic video camera may not determine the current shooting frame rate correctly. Therefore, the endoscopic video camera should be set at a high brightness sensing reference value.

The brightness compensation means 262 adjusts the luminance of the light source generator according to the exposure time of the digital images. As for the frame rate of 30 frames/sec, the exposure time for each frame of the image is 1/30 second. Therefore, the higher the frame rate is, the shorter the image exposure time is. Besides adjusting the exposure time, the operational unit 250 may also adjust the light acceptance capacity of the sensor 220 through adjusting the gain value of the sensor 220, such that the sensor 220 may also maintain at a certain frame rate at the low brightness environment. The storage unit 260 is electrically connected with operational unit 250, and used for storing the brightness calibration process 261 and the brightness compensation means 262.

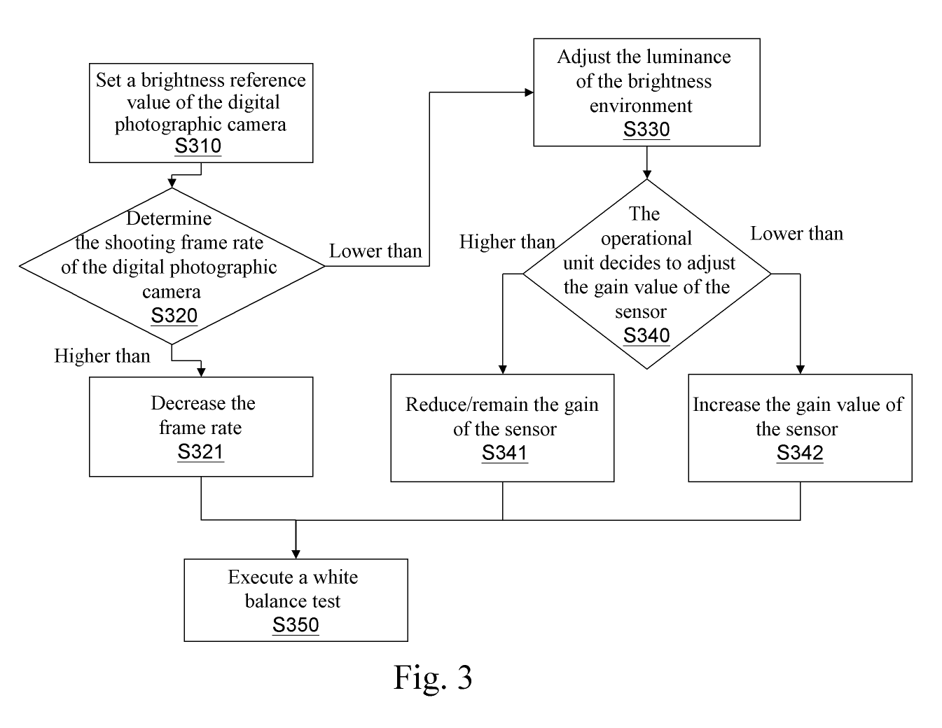

In order to clearly illustrate the operation procedure of the present invention, FIG. 3 is a schematic view of an operation procedure of the present invention. A brightness reference value of the digital photographic camera is set (Step S310). The brightness sensing reference value is used for adjusting the photosensitivity of the sensor 220. Then, whether to adjust the shooting frame rate of the digital photographic camera or not is determined according to the brightness reference value and the external brightness of the digital photographic camera (Step S320). If the frame rate is higher than a frame threshold, the frame rate is decreased (Step S321). In other words, the exposure time of each image is prolonged to increase the light acceptance mount of the sensor. In this embodiment, the frame threshold is 30 frames per second.

If the frame rate is lower than a frame threshold, the light source generator performs compensation. The luminance of the light source is adjusted (Step S330), such that the shooting frame rate of the digital photographic camera is higher than the frame threshold.

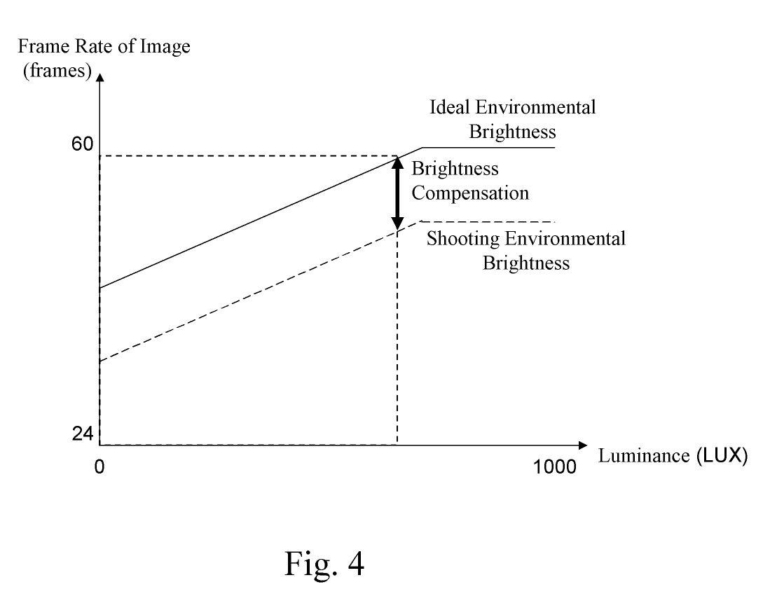

The digital photographic camera 200 adjusts the luminance of the light source generator 230 according to a frame rate to brightness look-up table or a frame rate to brightness curve. FIG. 4 is an external brightness to light source adjustment curve. In this embodiment, illuminance is used as the unit of the brightness. The illuminance refers to a density for accepting luminous flux on the light acceptance surface. A luminous flux of 1 lumen is uniformly distributed on a surface of 1 m² so as to generate a illuminance of ILUX. Different illuminance values are corresponding to different frame rates. When the shooting environment has a high illuminance and the sensor 220 remains the gain value unchanged, the frame rate is increased. When the shooting environment has a low illuminance and the sensor 220 remains the gain value unchanged, in order to ensure the sufficient light acceptance of the sensor 220, the exposure time of the image is prolonged, so as to reduce the frame rate.

According to the result of Step S330, the operational unit decides to adjust the gain value of the sensor (Step S340). If the shooting environment after the brightness compensation of the light source generator makes the frame rate to be higher than the frame threshold, the operational unit may reduce/remain the gain value (Step S341). On the contrary, if the frame rate is lower than the frame threshold, the gain value of the sensor is increased (Step S342). A white balance test is executed (Step S350), for determining the white balance of the input images of the digital photographic camera.

The present invention provides a digital photographic camera 200 with brightness compensation and a brightness compensation method thereof The digital photographic camera 200 is used to appropriately adjust the luminance of external light source of the digital photographic camera when shooting under different brightness environments. Thereby, the digital photographic camera 200 may maintain the frame rate of the digital images without reducing the image quality under different environmental brightness. Besides, the adjustment on the gain value of the sensor 220 is avoided, so as to reduce the image noise due to the increase the gain value.

What is claimed is:

1. A digital photographic camera with brightness compensation, applicable for the brightness compensation of the digital photographic camera when shooting under different brightness environments so as to maintain a frame rate of digital images, the digital photographic camera comprising:
a light measuring unit, for sensing an external brightness of the digital photographic camera;
a sensor, for shooting a plurality of frames of digital image;
a light source generator, for illuminating the digital photographic camera;
a light modulation unit, electrically connected with the light source generator, for controlling luminance of the light source generator;
a storage unit, for storing a brightness compensation means and a brightness calibration process; and
an operational unit, electrically connected with the storage unit, the light measuring unit, and the light source generator, and executing the brightness calibration process for calibrating a brightness sensing reference value of the light measuring unit and the brightness compensation means for adjusting the luminance of the light source generator.

2. The digital photographic camera with brightness compensation according to claim 1, wherein the brightness compensation means adjusts the luminance of the light source generator according to an exposure time of the digital images.

3. The digital photographic camera with brightness compensation according to claim 1, wherein the brightness compensation means adjusts the luminance of the light source generator according to a gain value of the digital photographic camera.

4. A brightness compensation method for a digital photographic camera, applicable for the brightness compensation of a digital photographic camera when shooting under different brightness environments, the compensation method comprising:
setting a brightness reference value of a digital photographic camera;
deciding a shooting frame rate of the digital photographic camera according to the brightness reference value and an external brightness of the digital photographic camera; and
adjusting a luminance of the light source generator, such that the shooting frame rate of the digital photographic camera is higher than a frame threshold.

5. The brightness compensation method for a digital photographic camera according to claim 4, wherein the step of adjusting the luminance of the light source generator further comprises:
if the luminance of the light source generator is adjusted to make the shooting frame rate of the digital photographic camera to be lower than the frame threshold, adjusting a gain value.

6. The method for brightness compensation of a digital photographic camera according to claim 4, after the step of adjusting the luminance of the light source generator, further comprising: executing a white balance test for judging the white balance of input images of the digital photographic camera.

7. The method for brightness compensation of a digital photographic camera according to claim 4, wherein the luminance of the light source generator is adjusted according to a frame rate to brightness look-up table.

8. The method for brightness compensation of a digital photographic camera according to claim 4, wherein the luminance of the light source generator is adjusted according to a frame rate to brightness curve.

9. The method for brightness compensation of a digital photographic camera according to claim 4, after the step of adjusting the luminance of the light source generator, further comprising:
determining whether to execute the step of deciding the shooting frame rate of the digital photographic camera repeatedly or not according to the external brightness of the digital photographic camera and the luminance of the light source generator.
